(19) United States
(12) Patent Application Publication
(10) Pub. No.: US 2016/0042459 A1
(43) Pub. Date: Feb. 11, 2016

(54) System and Method for Managing Derivative Instruments

(71) Applicant: trueEX Group LLC, New York, NY (US)

(72) Inventors: Sunil Hirani, Greenwich, CT (US); Katrina Bell, Barryville, NY (US)

(21) Appl. No.: 14/821,343

(22) Filed: Aug. 7, 2015

Related U.S. Application Data
(63) Continuation-in-part of application No. 13/864,988, filed on Apr. 17, 2013.
(60) Provisional application No. 62/034,470, filed on Aug. 7, 2014.
(60) Provisional application No. 62/040,689, filed on Aug. 22, 2014.
(60) Provisional application No. 61/687,088, filed on Apr. 17, 2012.

(51) Int. Cl. G06Q 40/06

(52) U.S. Cl. CPC G06Q 40/06

(57) ABSTRACT

The present invention is a system and method for providing improved management functions for derivative instruments. In order to allow a portfolio manager to convert existing positions to new positions with reduced parameters, including but not limited to, the total number of positions, and the total notional amount, a process is provided allowing a DM platform to generate potential transactions which compress eligible positions within a portfolio manager's portfolio to obtain such reduced parameters, with analytical support for the potential transactions.

### PRIORITY INFORMATION

The present application is a utility application, and claims priority to the U.S. Provisional Application Ser. No. 62/034,470, filed on Aug. 7, 2014, titled Blended Compressions, in the name of Sunil Hirani, and U.S. Provisional Application Ser. No. 62/040,689, filed on Aug. 22, 2014, titled Automated Blended Compression of Derivative Product Portfolios, in the name of Sunil Hirani, the contents of each of which are incorporated herein in their entireties by reference thereto. The present application is also a continuation-in-part of U.S. patent application Ser. No. 13/864,988, filed on Apr. 17, 2013, titled System and Method for Managing Derivative Instruments, in the name of Sunil Hirani and James Miller, which claimed priority to U.S. Provisional Application Ser. No. 61/687,088, filed on Apr. 17, 2012, titled Unwinds Concept, in the names of Sunil Hirani and James Miller, the contents of which are incorporated herein in their entireties by reference thereto.

### BACKGROUND

The present invention relates to the management of derivative based financial instruments, commonly referred to as swaps, and more particularly to a process for allowing a portfolio manager to reduce the number of positions held in a portfolio.

Interest rate swaps, such as simple swaps in which an offeror offers to swap the interest associated with a fixed rate for a notional amount for the interest associated with a variable rate on the same notional amount, or more complex transactions such as a swap involving a switch trade, which involves multiple swaps over different periods of time (referred to as the tenor of the swap) such as a 2×10 switch in which the offeror and an acquirer first implement a simple two year swap, followed by a 10 year swap with the roles reversed (i.e., the offeror first pays interest at a fixed rate, then changes roles and pays interest at a variable rate), allow financial entities to hedge risk associated with interest rates as they vary over time.

The ability of traders to optimize the holdings, also called positions, in a portfolio of derivative instruments is important. As markets and economies change, so does the optimal portfolio of derivative products for a company or trader, as the derivative instruments are frequently held as a hedge position, to reduce risk to the company or trader in the event of some market or economic trends. The need to manage derivative instrument holdings can be brought about by a company or trader's underlying financial obligations no longer existing, such as when a bond or loan which had been hedged has been repaid or called, by a company or trader changing its position on forward rates, or by a company or trader changing its hedge strategy itself, such as by seeking to extend or reduce swap tenors.

Thus, companies and traders may need to adjust the derivative instruments held in their portfolio of derivative instruments, such as reducing the number of instruments under which a fixed interest rate position has been taken counter to a variable interest rate position, or vice versa.

The ability to adjust a portfolio with respect to its content may not always be easy to accomplish. Previously entered into swaps may no longer enjoy liquidity, such as when the swap is no longer an “on-the-run” position, and interest in the terms of the swap has waned. Simply inducing a counter party to cancel out a swap, or “unwind” it, may have financial implications for the counter party, such that the counter party may seek remuneration for the unwind. Finally, margin considerations may complicate any efforts to manage a portfolio, as margin costs may be dependent on the particular positions at issue, the number of positions at issue, the related clearing houses, or other factors.

To this end, the first party trader may desire to reduce the number of different derivative instrument holdings within a portfolio, referred hereafter to as compaction or compression.

Portfolio managers may want to reduce the number of positions held in a portfolio, without changing the aggregate position in the portfolio. Such a desire may be accomplished by compressing or compacting the positions into a reduced number of positions or a single position, having a similar risk profile and obligations and benefits as the aggregated benefits and obligations of the non-compacted portfolio.

The management of existing positions may be dependent on valuing the present position, such as when the position is no longer being actively traded as well as connecting users and potential step-in parties, existing counterparties, and clearing houses to allow management of an existing portfolio. Compactions or compressions are readily feasible where the holdings in the group to be compressed or compacted all share common features, such as interest rates on the variable and fixed legs of the positions, the tenor of the positions, and the settlement date of the positions. Where these values are not the same, the resultant position cannot simply use the original parameters for the new position.

### SUMMARY OF THE INVENTION

The present application is a system and method for providing a derivative instrument management system that allows a user to efficiently and transparently compress or compact existing positions within a portfolio.

In a simple form, the system of the present invention is a computer implemented derivative management (“DM”) platform having a computer system including a plurality of user interfaces. The computer system may be provided with functionality to enable the DM platform to analyze derivative instrument portfolio information, including information obtained from external sources, to generate potential compression packages which reduce one or more parameters of one or more derivative instruments held within the portfolio. The DM platform may be provided with data storage, a network interface, a data acquisition module, a pre-processing module, a position analytics module, a package generation module, a user communications module, and a compression package implementation module.

The present invention is also embodied in a process for analyzing a group of derivative instruments to generate potential transactions which reduce one or more parameters of one or more derivative instruments held within the portfolio, the process comprising the steps of receiving at a derivative management platform trade position data, pre-processing the trade position data to identify positions amenable for compression, generating and analyzing potential trades which compress said amenable positions, and communicating to a portfolio manager responsible for said amenable positions information describing said potential trades which compress said amenable positions.

### BRIEF DESCRIPTION OF THE FIGURES

FIG. 1 illustrates an exemplary derivative management platform for implementing blended compressions.

FIG. 2 illustrates an exemplary information display showing a potential flat package compression.

FIG. 3 illustrates an exemplary information display showing a potential zero notional package compression.

FIG. 4 illustrates an exemplary information display showing a potential out of bound package compression.

FIG. 5 illustrates an exemplary information display showing a potential dual package compression.

FIG. 6 illustrates an exemplary information display showing a potential single package compression.

FIG. 7 illustrates an exemplary information display showing a potential standard instruments package compression.

FIG. 8 illustrates a process implementing automated simple blending with bilateral participants.

FIG. 9 illustrates a process implementing complex blending with multilateral participants.

FIG. 10 illustrates a process implementing complex blending with bilateral participants.

FIG. 11 illustrates a process implementing complex blending with multiple participants.

FIGS. 12A and 12B illustrate an exemplary position compression proposal for a complex blending with bilateral participants.

FIG. 13 illustrates a summary report at the portfolio level for a first party involved in a multiple participant complex blending transaction.

FIG. 14 illustrates an exemplary information display for a potential compression for a set of swaption positions.

FIG. 15 illustrates potential data to be received by the DM platform for enabling the generation of potential compression packages.

### DETAILED DESCRIPTION OF THE INVENTION

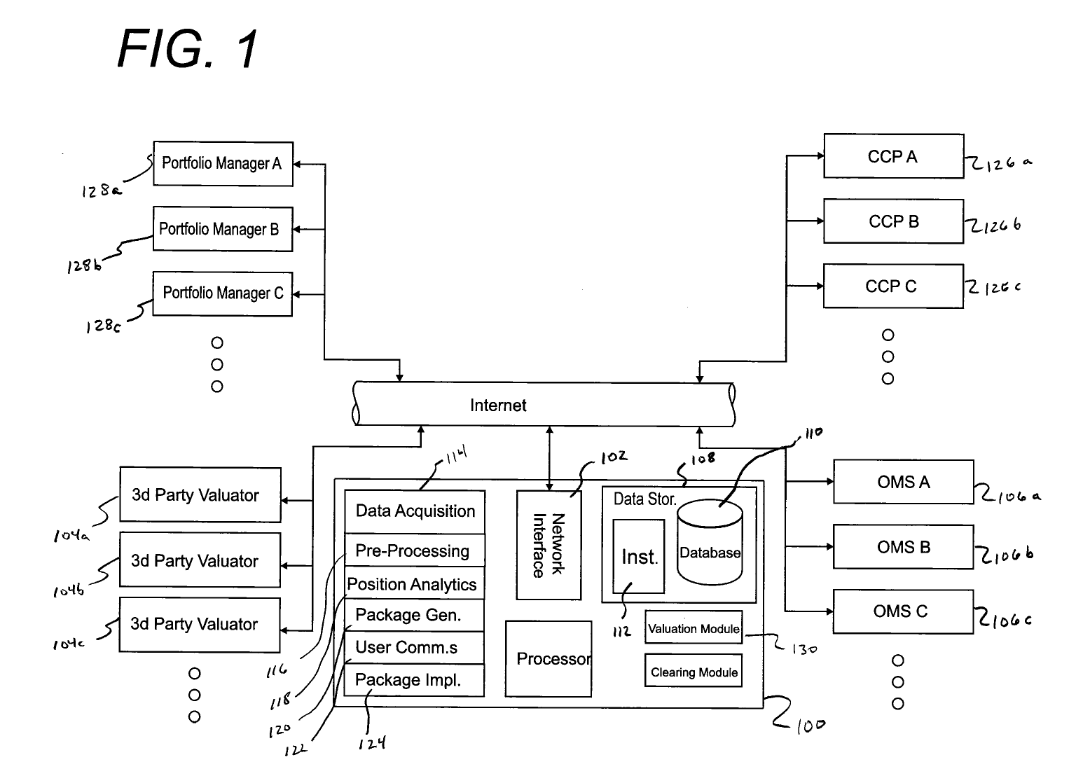

As shown in the Figures, in which like numerals are used to identify like elements, there is shown an embodiment of the present invention. In FIG. 1, there is shown a derivative instrument management platform 100 for implementing blended compressions or compactions of derivative instruments.

The derivative management platform 100 (hereafter “DM platform”) may utilize multiple functional modules, to address different aspects of the process associated with providing the derivative instrument management platform. While these are described in terms of modules, nothing requires modular construction of the system and method in accordance with the present invention, modules are simply used for the added clarity they allow to the below discussion.

The DM platform may function as a central repository of the trade positions of multiple portfolio managers across central clearing parties (CCP's). The DM platform may allow the portfolio managers to hold their positions either en masse, or within portfolio manager defined subsets, such as may be used to associate specific positions with specific clients or concerns.

The DM platform may be used to automatically identify positions within either a portfolio or a subset of a portfolio to identify positions which may be beneficially compressed for the portfolio manager. Alternately, a portfolio manager may identify particular positions which the portfolio manager desires to be compressed. Under such manual selection, the portfolio manager may select such positions by reviewing a list of positions held, and selecting particular positions by checking a field associated with the position.

The DM platform may automatically identify positions to propose compression on based on similarities between the positions. For example, the DM platform may sweep a portfolio or subset of a portfolio to identify positions within the portfolio or subset having settlement dates within a specific range. The DM platform may utilize an algorithm to analyze a portfolio or subset to identify positions having settlement dates within a thirty day window, such that the positions may be aggregated, with fixed and variable leg interest rates netted to allow compression of the positions. The DM platform analytics may additionally include margin impacts to capture margin impact against the house account end of day margin and variation margin.

The DM platform analytics may consider proposed compressions using blending methodologies based on the types of positions within the portfolio or subset or on the desired characteristics of the resultant compressed position or positions, as discussed further below. The process may seek to generate proposed replacement packages through an iterative bilateral or multilateral process that nets down cleared trades, terminates non-cleared trades, and seeks to replace exact near risk with a smaller set of positions. The compression of non-uniform positions necessarily results in one or more of the characteristics of the positions being “blended” to allow the reduction in positions. The goal of the blending may typically be to result in an identical net present value. Such blending may be either simple or complex.

Simple one-sided blending can be executed unilaterally at a clearinghouse. There are six types of simple blending. Each CCP may have an agreed on approach and unique blending identifiers for unilateral blending, replacing trades that match all attributes of the swap. Variable attributes may include the notional amount and the interest rates involved. The direction of the swap may be pay or receive. It is also important to note that past details of the trade are not relevant and only the future details are typically considered. Each position may be calculated looking to the future attributes only and the Net Present Value (NPV) may be assessed from the day of blending to the swap termination date.

When the DMS analyzes the potential results of a blending method, the other side of the swap may be a suspense account, where the total NPV of each individual trade matches exactly to the cent the sum of the replacement trade(s). If implemented, the CCP may terminate the offsets and original trades such that only the new trades remain. Simple one-sided blending eligibility is easily validated during the package proposal process and at the CCP in the overnight processing physically terminating the trades with matching blending keys.

Simple blending may be of one of 6 types; flat packages, zero notional packages, out of bounds rate packages, dual packages, single packages, and daily averaging of standard instruments packages.

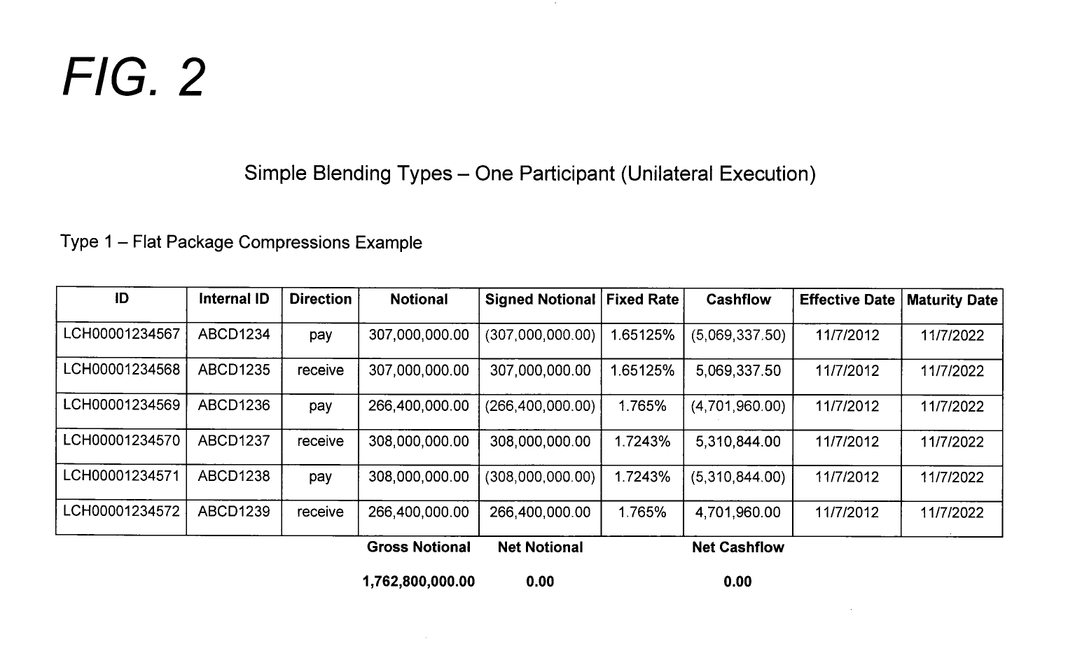

Flat packages have a zero net notional, i.e., the notional of the resultant package is the same as the aggregate notional of the original positions, and the net cash flow of the resultant package is also zero. Flat packages may not require replacement trades and may be submitted for netting. An example of a flat package the values associated with a notional compression is shown in FIG. 2.

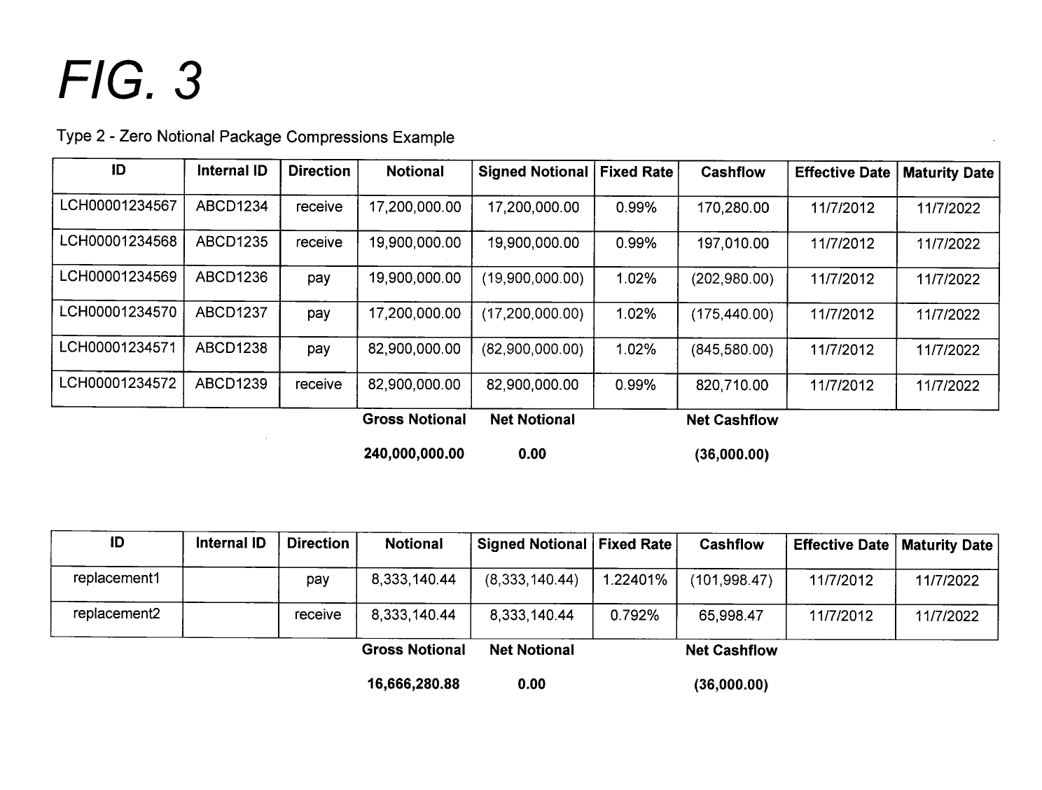

Zero notional packages have a zero net notional, but may have net cash flows that are more or less than zero. Zero notional packages may be replaced by two offsetting trades that have different cash flows with the two replacement trades being calculated to preserve the notional and match the cash flow as closely as possible. An example of the values associated with a zero notional compression is shown in FIG. 3.

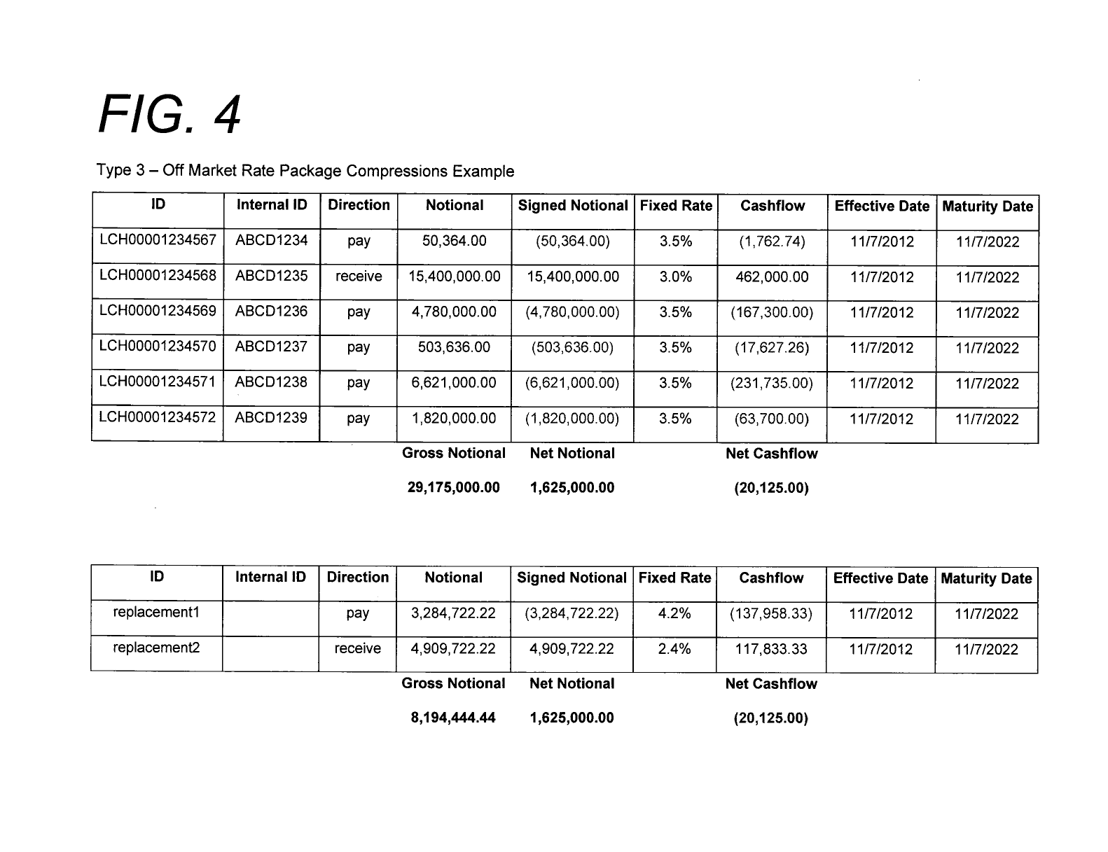

Out of bound rate packages may utilize a blended rate for the resultant package based on the minimum rate in the group of positions to be compressed, or a blended rate for the resultant package based on the maximum rate in the group of positions to be compressed. The group of positions to be compressed may be replaced by two trades in opposite directions with rates close to the minimum and maximum rates from the group of positions to be compressed. Two reasonable and observable market rates, appropriate to that securities tenor and original term structure, are used to replace the package set of trades. The use of market rates based on the characteristics of the group of positions to be compressed may avoid incurring additional regulatory requirements. An example of the values associated with an out of bound package is shown in FIG. 4.

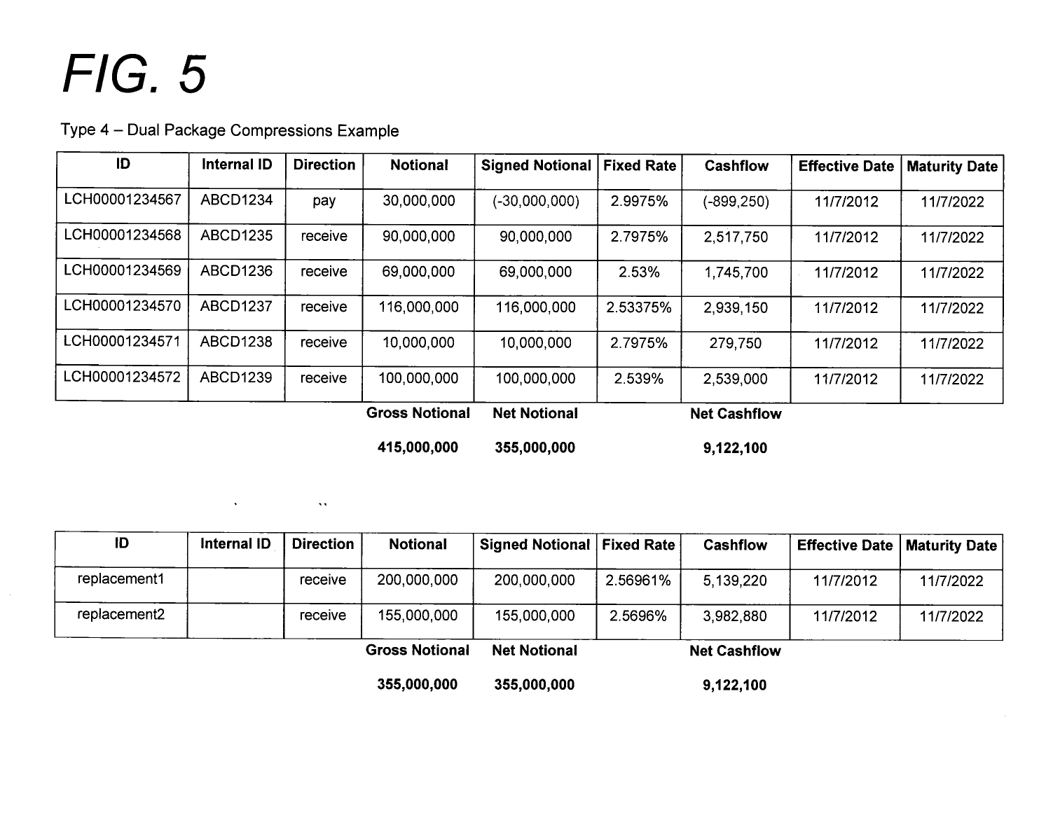

Dual packages utilize a blended rate that has more than a maximum number of designated decimal places (as typically set by a CCP) for the value of the blended rate. The group of positions to be compressed may be replaced by two trades having the same direction, with a weighted rate that falls within the within the range of the interest rates of the group of positions to be compressed, and is adjusted by an up or down factor dependent on the maximum decimal places imposed by the CCP. The notional value of the two replacement positions may be determined by a notional factor. An example of the values associated with a dual package is shown in FIG. 5.

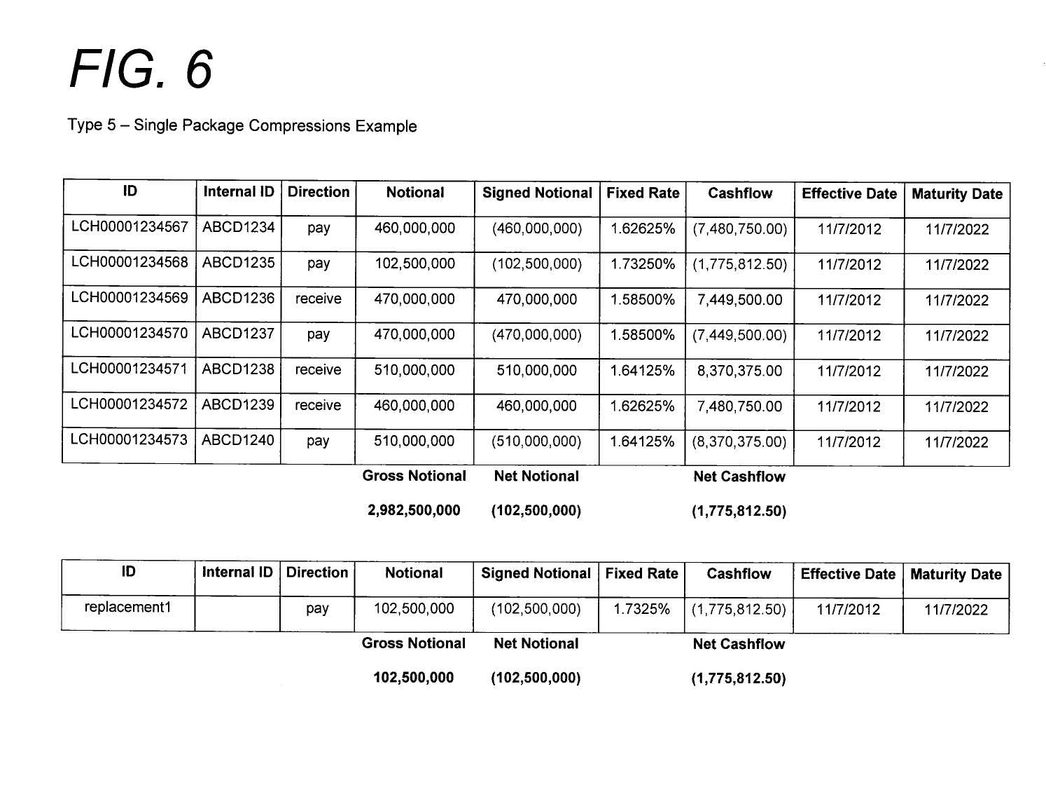

Single packages may utilize a blended rate that has the maximum designated number of decimal places, or a blended rate having less than the maximum designated number of decimal places. The group of positions to be compressed may be replaced with a single position. An example of the values associated with a single package is shown in FIG. 6.

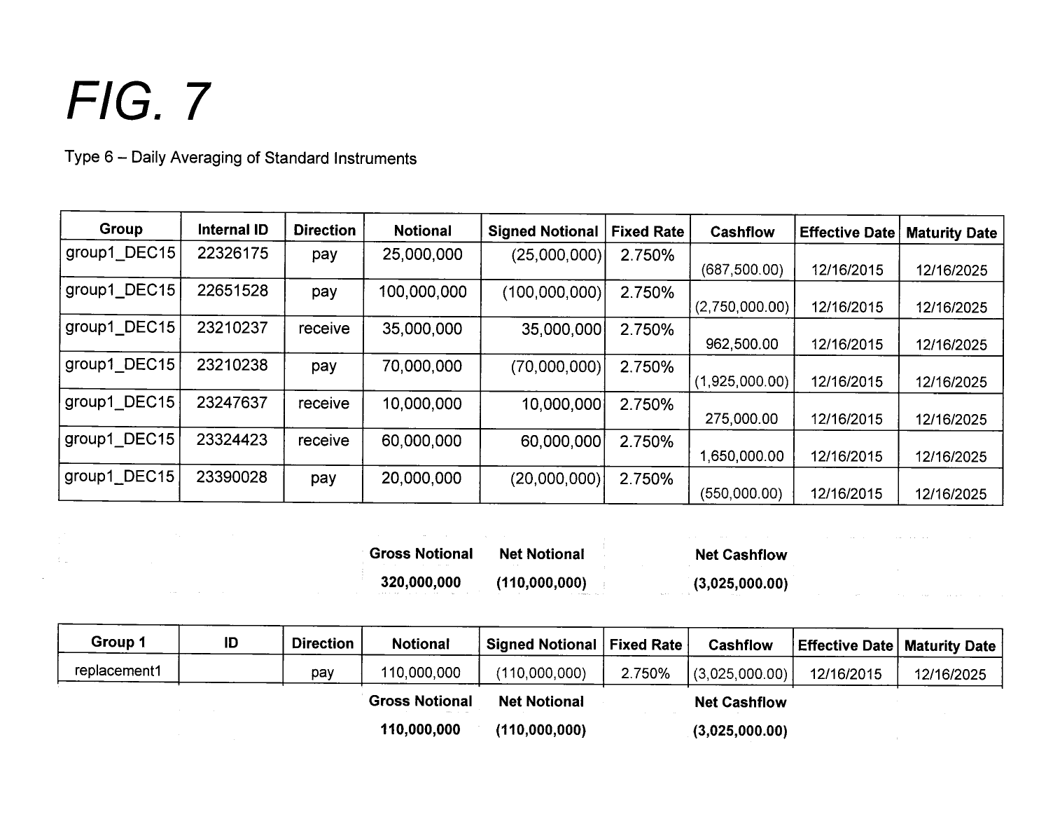

Daily averaging of standard instrument packages may address Market Agreed Coupon (MAC) positions with the same attributes. MAC trades are Market Agreed Coupons that should promote liquidity and are more fungible to manage blending and netting of these trades types. Securities Industry and Financial Markets Association (SIFMA) publishes a standard rate for each quarterly IMM date with a CUSIP. If the markets are volatile and move too far Off-Market, SIFMA may publish a second series for the same contract period. MAC like trades are set by the participant and can change by their own volition if the market moves too far away from the published SIFMA rate for that contract term. Simple netting of this package type will result in a single trade for each subset of positions having the same attributes. The resultant position may have a rate having less than the maximum designated number of decimal places, or a rate having the maximum number of designated decimal places. Alternately, the resultant package may have two positions, with one position being executed as an election by the portfolio manager when the portfolio manager sets up their preference. An example of the values associated with a daily averaging of standard instruments package is shown in FIG. 7.

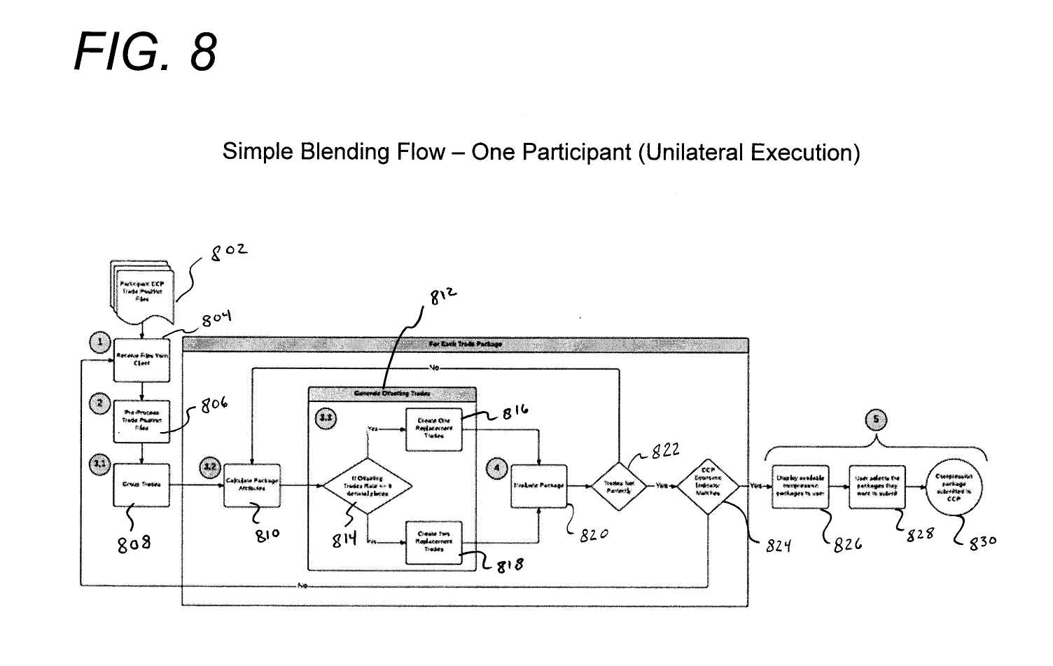

FIG. 8 illustrates a process implementing automated simple blending, implemented using four phases: delivery of trade position data; pre-processing of amendable positions; grouping and calculation of potential replacement trades; evaluation and approval of suggested compressions by the portfolio manager; and execution of approved suggested compressions. In the Figure, the phases of the process are indicated by the circled numbers. The process may be started by the portfolio manager/participant's trade position files being received 802 from a CCP. The portfolio manager may also provide 804 portfolio information, such as from an OMS. The trade position files and portfolio information may then be pre-processed 806 to standardize the date in a format compatible with the DM platform analytics. Positions may then be grouped 808, either manually by the portfolio manager, or automatically by the DM platform, into groups suitable for consideration and evaluation for potential compression transactions. The attributes of the groups may then be calculated 810, including but not limited to NPV values, maximum and minimum rates for the group, and total notional values. From this information, potential compression transactions may be generated 812. Because of restrictions on the number of decimal places for interest rates that some CCP's may impose, the number of decimal places for the generated potential compression transactions may be tested 814 to determine if the calculated rate complies within an allowable range using the maximum number of decimal places allowed. If the calculated rate is within range within the allowable number of decimal places, a single transaction may be created 816 for the potential compression package. If the calculated rate is not within range within the allowable number of decimal places, two offsetting transactions may be created 818, to allow the interest rates to be blended to both meet the decimal place requirement, as well as be within an allowable range of the calculated rate. The package may then be evaluated 820 with respect to the parameters that would be achieved through the potential compression. If it is determined 822 that the trades do not net perfectly, the generation process may be restarted. If it is determined 822 that the trades net perfectly, the potential package may be evaluated 824 to determine whether CCP economic indicators match the potential transaction. If the economic indicators do not match, the process may be restarted. If the economic indicators match, the potential compression package may be displayed 826 to the portfolio manager, who can select 828 any potential compression packages that the portfolio manager desires to implement. Selected compression packages can then be implemented 830, such as by being submitted to a CCP for execution.

For complex blending, access to each Participant's full bilateral and cleared portfolios, along with CCP margin calculators, will allow the DMS system analytics to determine the population of trades for complex blending that benefits both buy-side and sell-side participants. The analytics may be participant agnostic. The goal of the process may be to reduce the Credit Value Adjustment (“CVA”) through reduction of the notional for better capital efficiency with a lower CCP margin. Complex blending may be configured in several ways to address an individual portfolio manager's needs.

In a capital efficiency configuration, participants may choose between three preferences regarding compression analysis depending on their primary requirement: leverage ratio relief; notional reduction; and line item reduction.

In a leverage ratio relief configuration, the compression analysis will prioritize packages factoring for potential future cash flow, which takes into account credit conversion factor by tenors; generally referred to as Potential Future Exposure (PFE). The configuration may utilize one or more recognized capital model, such as Current Exposure Method (CEM), to calculate the replacement package, and factor in Mark-to-Market (NPV), gross and net notional with potential future cash flow, and also take into account credit conversion factor by tenors in order to generate a proposed replacement package.

In a notional reduction configuration, the compression analysis will focus on proposing packages that reduce the gross notional as the highest priority.

In a line item reduction, the compression analysis will focus on proposing packages that reduce the number of swap positions even if gross notional cannot be significantly reduced.

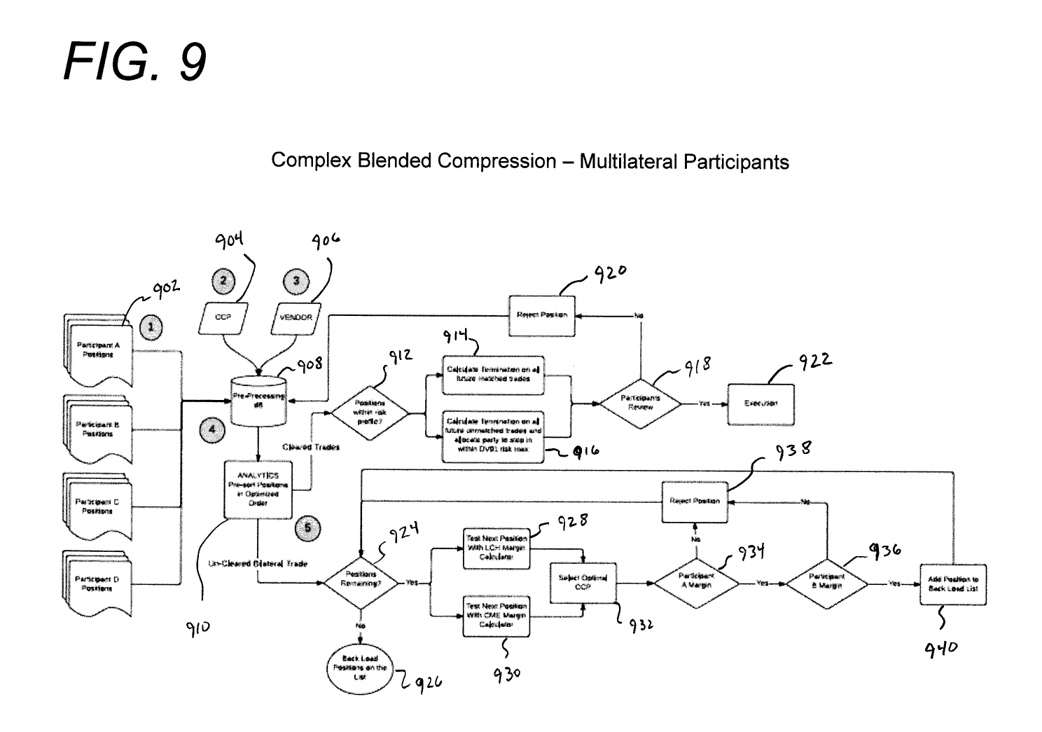

As shown in FIG. 9, five phases are involved in pre-processing a complex blended compression analytic involving multiple participants. These phases are receiving the trade position data, receiving the CCP, IM, and tenor sensitivity reports which are published by the end of the day; receiving middleware or order management systems (OMS) information; pre-processing the data to standardize the data for the compression analytics; and generating proposed packages. In the Figure, the phases of the process are indicated by the circled numbers. At the outset, the information of multiple potential participants may be obtained 902. Position information from CCP's and OMS's may also be obtained 904, 906. This information may be pre-processed 908 to standardize the information, to allow the attributes of the portfolios of the multiple participants to be evaluated. The DM platform analytics may then pre-sort 910 the positions into an optimized order for consideration for inclusion in potential compression packages. Cleared trades may be subjected to a first process, comprising first determining 912 whether a cleared position was within the responsible portfolio manager's risk profile. If a trade was not within the responsible portfolio manager's risk profile, the cleared trade would not be considered for inclusion within a potential compression package. Termination parameters could then be calculated 914 for all future matched trades, and termination parameters could also be calculated 916 for all future unmatched trades to identify potential step in parties within a DV01 maximum allowable risk. The responsible portfolio manager, and potential step in parties, could the review 918 the potential compression transaction package, and either accept or reject the package. If the package were rejected 920, the process could restart with evaluation of additional positions within he portfolio manager's portfolio, or could move on to a different portfolio manager's portfolio if all of the positions within the first portfolio manager's portfolio had been considered. If the package were accepted 922, the package could be executed, such as through a CCP.

For un-cleared bilateral trades, an iterative process could be performed, iterating through each of the un-cleared bilateral positions within a portfolio until all had been considered 924, at which time all positions which had been determined amenable for inclusion in a potential compression package could be back loaded 926 into the potential package. For each position, the potential margin resultant from compressing the position with alternate CCP's, such as LCH and CME, could be calculated 928, 930, such that the optimal margin could be selected 932. If the optimal margin identified was within 934 the margin tolerance of the portfolio manager responsible for the position, the optimal margin could then be tested 936 against the margin tolerance of a potential step in party. If the optimal margin identified was outside of the margin tolerance of either the portfolio manager or the potential step in party, the position could be rejected 938 as not being amenable for inclusion in a potential compression package. If the optimal margin was within the margin tolerance of both the portfolio manager and the potential step in party, the position could be added 940 to back load list for inclusion in the potential compression package.

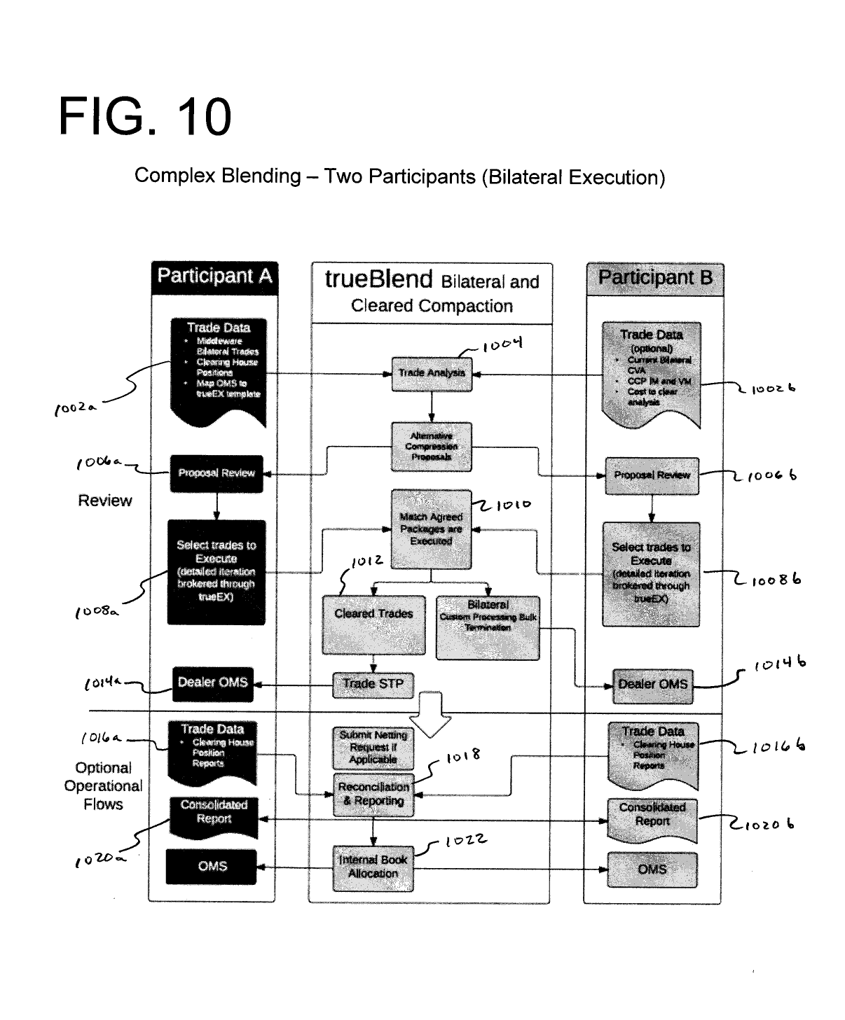

FIG. 10 illustrates a complex blending process involving two participants. As can be seen from the Figure, the pre-processing steps for participants A and B are implemented in steps 1002a and 1002b. The DMS may then analyze the portfolio and trade data to generate 1004 alternative compression proposals, which can then be communicated to the participants to allow the participants to review 1006a and 1006b the compression proposals. Each participant may then select compression proposals to execute 1008a and 1008b, which may be communicated to the DM platform. The DM platform may then match 1010 agreed compression proposals and execute those agreed compression proposals, clearing the trades 1012 as necessary, and reporting the trades parameters to the respective order management systems 1014a and 1014b.

Once the bilateral compression has been implemented, additional processing can occur to assist the respective participants in managing their portfolios. This processing may the trade data being reported 1016a and 1016b to the participants, from the respective CCP's, such that the participants can reconcile 1018 the transactions through the DM platform, and the DM platform can issue 1020a and 1020b consolidated reports for the participants reflecting the implemented compression transactions, and the participants can allocate 1022 the results of the transaction to their own internal books. Finally, the results of the transaction, and any additional processing, can be reported 1024a and 1024b by the DM platform to the participants' outside management systems.

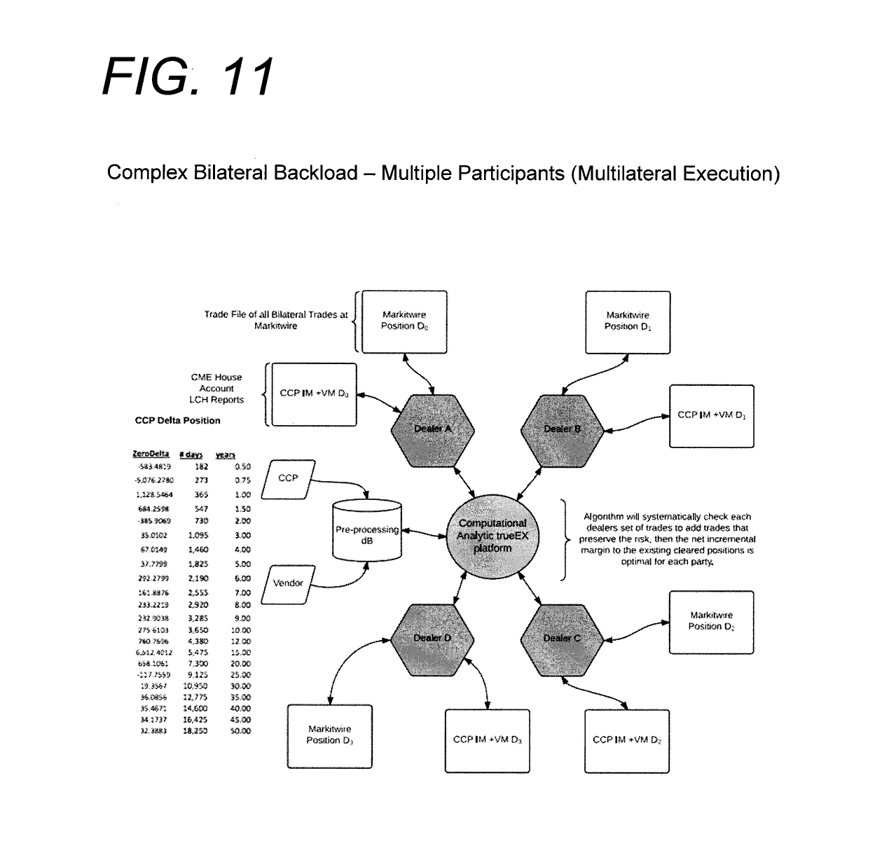

FIG. 11 illustrates a multilateral compression involving multiple participants. The pre-processing discussed above is implemented, such that the positions and CCP data from each participant is received, and stored in a pre-processing database, preferably in standardized form. The DM platform may then perform the analysis to identify potential compression packages for the participants, with the same process illustrated in FIG. 10 above being implemented with respect to the multi-party participants.

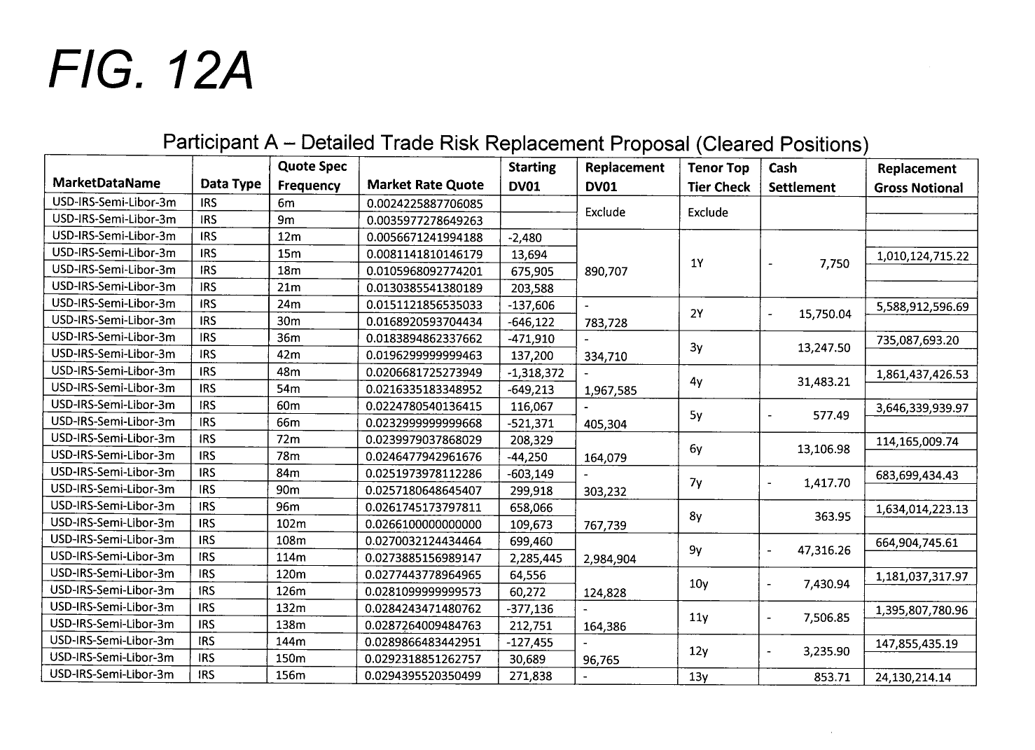

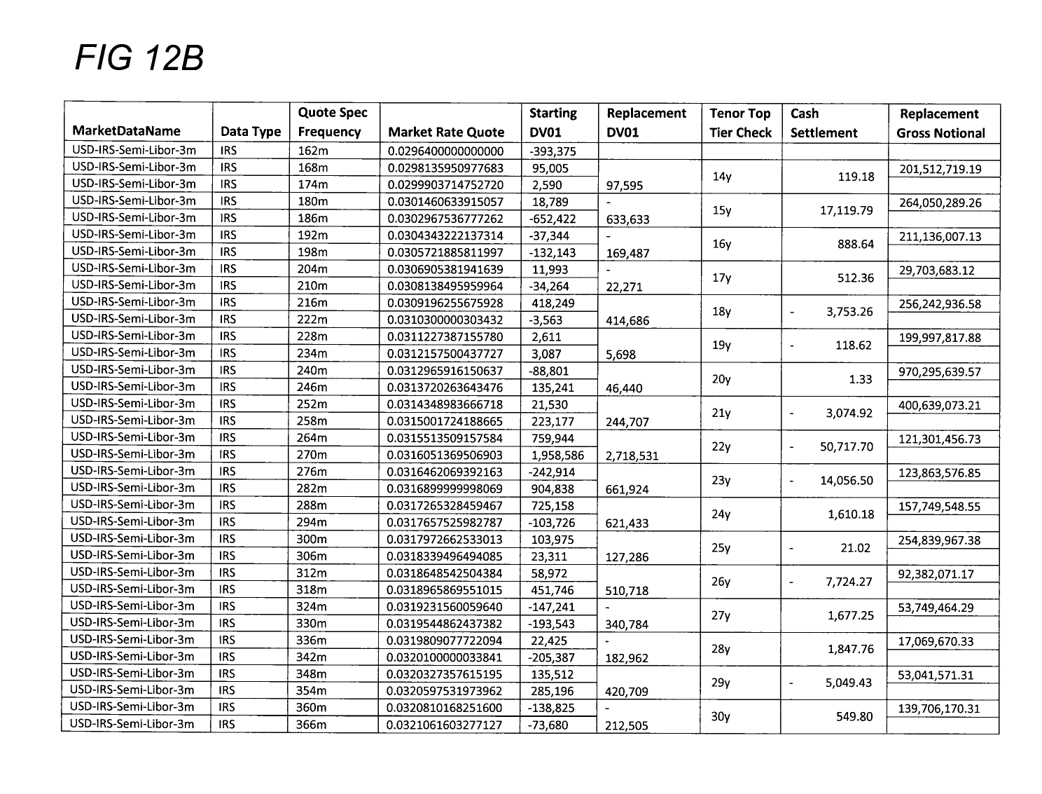

FIG. 12 illustrates a notional detailed trade risk replacement proposal for Participant A for the process shown in FIG. 10 above. The detailed proposal identifies the parameters of the positions both prior to the proposed compression, as well as after the proposed compression, including any cash settlement involved in the compression.

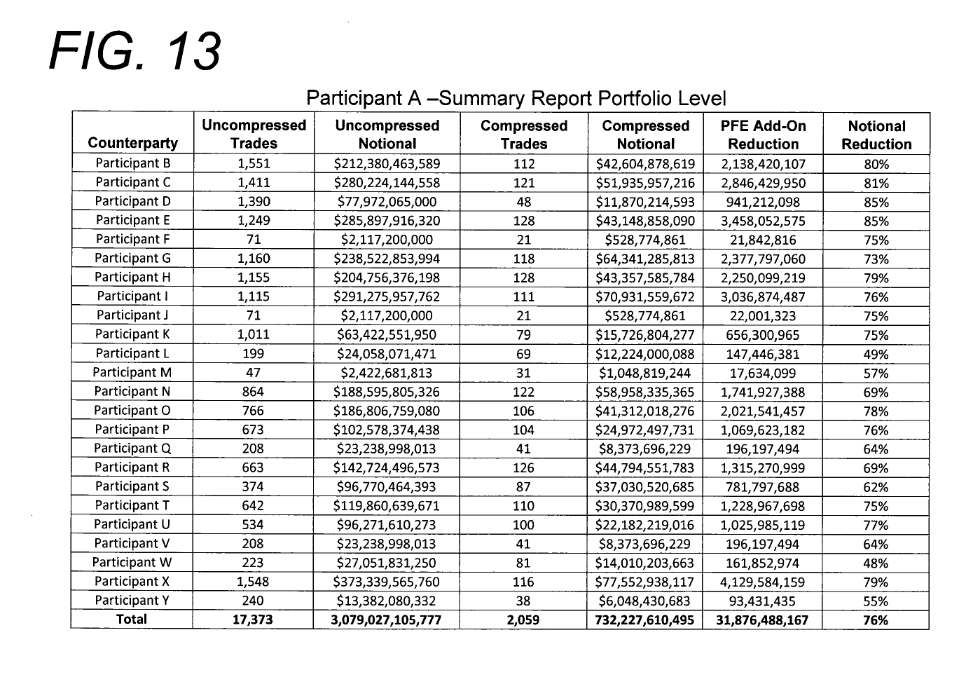

FIG. 13 illustrates a notional summary report at the portfolio level for a first participant involved in a multi-party transaction, such as shown in FIG. 11, identifying the counterparties for the first participant for proposed compression packages, as well as the potential results from the proposed compression.

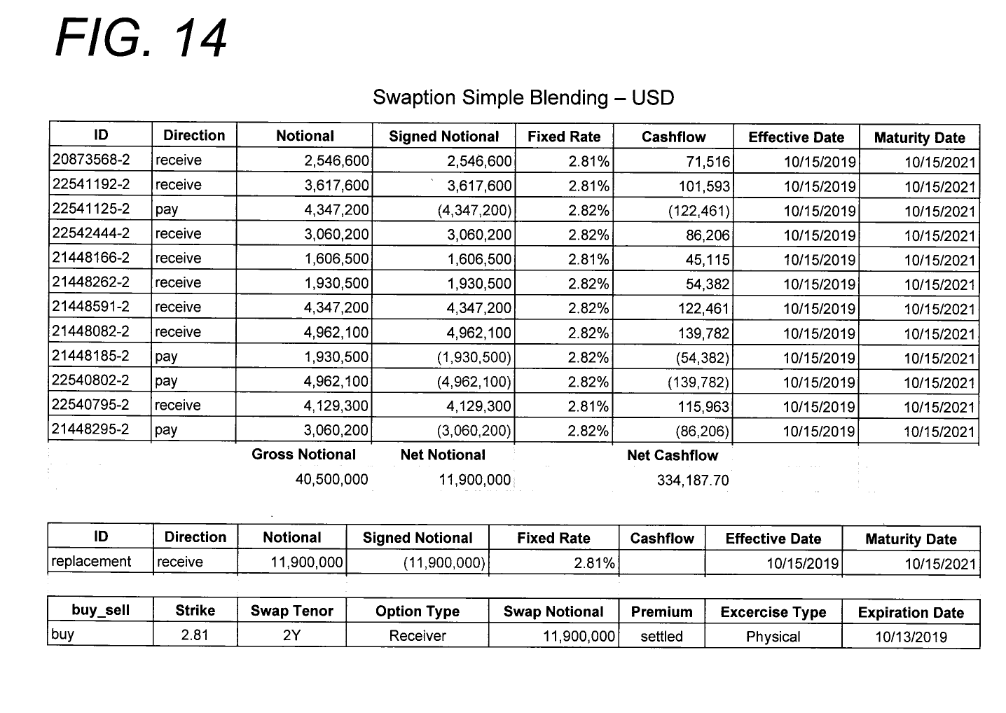

In addition to being utilizable for cleared positions, the present process may be utilized for non-cleared positions as well. For example, options are currently traded over the counter, and are not necessarily cleared though a CCP. Such positions may be blended in accordance with the process described above for simple blending, however the proposed package would be bilateral, such that implementation of a proposed package would need concurrence from the option counterparty. FIG. 14 illustrates a proposed compression for a set of swaption positions held by a participant, including the resultant net notional and net cash flow characteristics of the proposed compression. Communication of the proposed compression to the counterparty or counterparties could be accomplished either directly through the DMS, or through external communications.

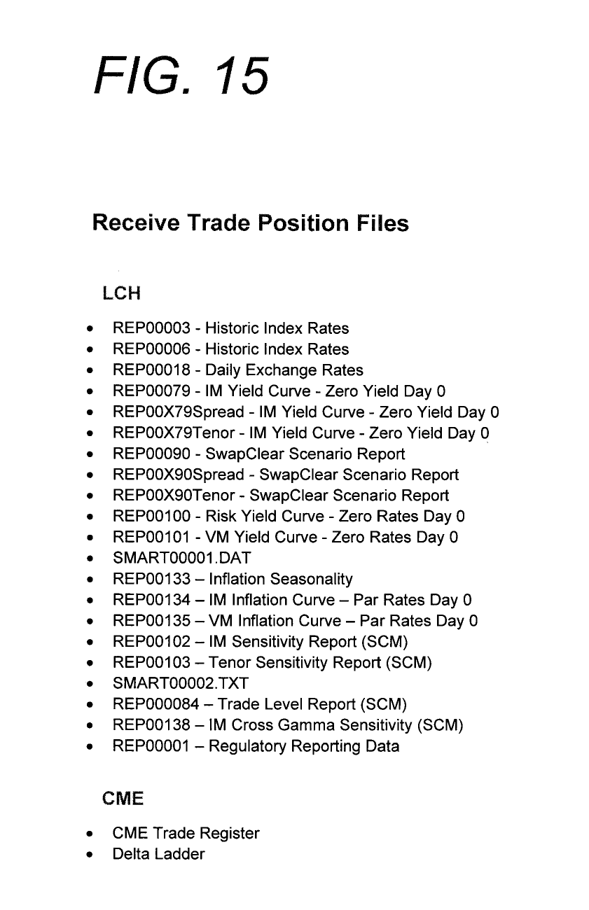

The data for the pre-processing for analyzing potential compression transactions may include trade position files, such as those shown in FIG. 15, which identifies data to be received from particular CCP's, such as LCH (London Clearing House) and CME (Chicago Mercantile Exchange).

Returning to FIG. 1, the above process for proposing and implementing blended compressions of a portfolio manager's positions may be implemented in a DM platform 100 by providing the platform 100 with functionality to allow it to implement the above described process. The DM platform may include a network interface 102 to allow communications between the DM platform and external resources, such as third party valuators 104a, 104b, . . . central clearing parties, and outside management services 106a, 106b, 106c, . . . , to enable the DM platform 100 to acquire information necessary for implementing a compression process. The DM platform 100 may additionally have data storage 108 to allow information regarding positions held by platform users (also referred to as portfolio managers or participants.) The data storage may preferably be in the form of a database 110, allowing more efficient correlation of the data involved. The memory storage may additionally provide storage 112 for instructions which allow the computer to perform the compression process.

The DM platform 100 may additionally be provided with a functional module 114 which allows the DM platform to acquire necessary data from external sources to determine characteristics and parameters of positions held by a portfolio manager. The data acquisition capability can be further used to acquire information identifying positions held by a portfolio manager. The pre-processing functional module 116 may allow the DM platform to standardize received and/or stored date to allow the DM platform to analyze the information to identify potential compression packages, based on positions held within a portfolio. A position analytics functional 118 module allows the DM platform to analyze positions held within portfolios to identify potential subsets for compressions, to analyze the effect of such potential compressions on the portfolio, and to select potential compressions for presentation to a portfolio manager. A package generation functional module 120 may be provided to generate proposed packages for presentation to portfolio managers, identifying potential compressions selected by the position analytics module. A user communications functional module 122 may be provided to implement communications between a portfolio manager and the DM platform, including selection by a portfolio manager of desired settings with respect to the compression functionality, presentation and review of proposed compression packages, and communication between the DM platform and the portfolio manager regarding the results of implementation of a compression package. Finally, a package implementation functional module 124 may be provided to implement accepted compression packages, including communicating the parameters of a package to CCP's 126a, 126b, . . . , and OMS's, as well as the involved portfolio manager or managers 128a, 128b, . . . .

The compression review process may be initiated by a portfolio manager requesting review of a portfolio or a subset of a portfolio to identify potential compression packages, of it may be implemented as an automatic function, such that the DM platform 100 performs a review each day after the close of business. The frequency of review may be set at different periods, such as weekly, monthly, or other, at the discretion of the portfolio manager. Whether the review is started manually or automatically may be selected by a portfolio manager through queries from the DM platform 100. Configuration information for the review process may additionally be provided to the DM platform by the portfolio manager.

Because of the necessity of using net present value, as well as other estimations regarding parameters and characteristics of positions and potential compression packages with respect to analyzing potential portfolio compressions, the DM platform 100 may be provided with internal capabilities to determine valuations 130 of positions for consideration within potential compression packages, as well as access to third party valuators, to allow the DM platform 100 to implement the above described process.

The present invention may be embodied in other specific forms without departing from the spirit or essential attributes of the invention. Accordingly, reference should be made to the appended claims, rather than the foregoing specification, as indicating the scope of the invention.

What is claimed is:

1. A computer-implemented derivative instrument management system comprising:
a computer platform having: data storage, a network interface, a data acquisition module, a pre-processing module, a position analytics module, a package generation module, a user communications module, and a compression package implementation module;
wherein said position analytics module analyzes positions held within a derivative instrument portfolio to identify positions amenable to a compression process, and wherein said package generation module generates proposed compression packages based on positions determined to be amenable to a compression process by said position analytics module.

2. A computer implemented derivative instrument management system according to claim 1, further comprising a valuation module for determining present net value of positions held within a derivative instrument portfolio.

3. A computer implemented derivative instrument management system according to claim 1, wherein said position analytics module analyzes positions held by a plurality of derivative instrument portfolios.

4. A computer implemented derivative instrument management system according to claim 1, wherein said package generation module generates potential simple blending compression packages.

5. A computer implemented derivative instrument management system according to claim 4, wherein said simple blending compression package is a flat package.

6. A computer implemented derivative instrument management system according to claim 4, wherein said simple blending compression package is a zero notional package.

7. A computer implemented derivative instrument management system according to claim 1, wherein said package generation module generates potential complex blending compression packages.

8. A computer implemented derivative instrument management system according to claim 7, wherein said simple blending compression package is a bilateral package.

9. A computer implemented derivative instrument management system according to claim 7, wherein said simple blending compression package is a multilateral package.

10. A computer implemented derivative instrument management process for generating proposed compression packages, comprising the steps of:
Receiving at a derivative management platform trade position data;
Pre-processing said position data to identify eligible positions;
Generating and analyzing potential trades which compress said eligible positions;
Communicating to a portfolio manager responsible for said eligible positions information describing said potential trades which compress said eligible positions; and
When said portfolio manager approves implementation of one or more of said potential trades which compress said eligible positions, implementing said one or more approved potential trades which compress said eligible positions.

11. A computer implemented derivative instrument management process for generating proposed compression packages in accordance with claim 10, wherein said step of generating potential trades which compress said eligible positions comprises a simple blending compression.

12. A computer implemented derivative instrument management process for generating proposed compression packages in accordance with claim 11, wherein said simple blending compression comprises a flat package compression.

13. A computer implemented derivative instrument management process for generating proposed compression packages in accordance with claim 11, wherein said simple blending compression comprises a zero notional package compression.

14. A computer implemented derivative instrument management process for generating proposed compression packages in accordance with claim 11, wherein said simple blending compression comprises an out of bounds package compression.

15. A computer implemented derivative instrument management process for generating proposed compression packages in accordance with claim 11, wherein said simple blending compression comprises a dual package compression.

16. A computer implemented derivative instrument management process for generating proposed compression packages in accordance with claim 11, wherein said simple blending compression comprises a single package compression.

17. A computer implemented derivative instrument management process for generating proposed compression packages in accordance with claim 11, wherein said simple blending compression comprises a daily averaging of standard instruments package compression.

18. A computer implemented derivative instrument management process for generating proposed compression packages in accordance with claim 10, wherein said step of generating potential trades which compress said eligible positions comprises a complex blending compression.

19. A computer implemented derivative instrument management process for generating proposed compression packages in accordance with claim 18, wherein said complex blending compression comprises a bilateral participant package compression.

20. A computer implemented derivative instrument management process for generating proposed compression packages in accordance with claim 18, wherein said complex blending compression comprises a multilateral participant package compression.
